(19) United States
(12) Patent Application Publication
(10) Pub. No.: US 2022/0183304 A1
(43) Pub. Date: Jun. 16, 2022

(54) WOOD-BURNING OVEN

(71) Applicants: Guram Giviyevich NEMSADZE, Dnipro (UA); Revaz Anzorovich DZHODZHUA, Dnipro (UA)

(72) Inventors: Guram Giviyevich NEMSADZE, Dnipro (UA); Revaz Anzorovich DZHODZHUA, Dnipro (UA)

(21) Appl. No.: 17/429,512

(22) PCT Filed: Aug. 23, 2019
(86) PCT No.: PCT/UA2019/000110

§ 371 Date: Aug. 9, 2021

(30) Foreign Application Priority Data
Feb. 28, 2019 (UA) A 2019 02020

(51) Int. Cl. A21B 1/33; F27D 1/02; F27D 1/04; F27D 17/00; F24B 1/20

(52) U.S. Cl. CPC A21B 1/33; F27D 1/025; F24B 1/20; F27D 17/002; F27D 1/04

(57) ABSTRACT

The invention relates to wood-burning ovens and may be used for preparing food, in particular, baked items, for example, pizza.

### FIELD OF THE INVENTION

The invention relates to wood-burning ovens and may be used for preparing food, in particular, baked items, for example, pizza, outdoors under field conditions, under allotment and family garden conditions, in outdoor cafes and restaurants, recreation sites provided with specially allotted locations for preparing food.

### DESCRIPTION OF THE PRIOR ART

Known from the state of the art is a wood-burning oven for preparing food comprising a built-up base; an arched top located above the built-up base; a rear wall that connects the built-up base to the arched top and forms, along with the arched top, a working space of the wood-burning oven, which is intended for burning fuel and for a subsequent placement of items for baking, in particular, pizza, therein; a chimney installed at the upper portion of the arched top the arched top being made of two rows of bricks constructed of refractory clay and having a rectangular shape (see http://www.kamin-pro.com.ua/products/pizza/). The internal (first) row of bricks of the arched top is made of refractory clay while the external (second) row of bricks of the arched top is made of lining brick. Joints between the bricks, which form the above-mentioned rows of the arched top, are filled with mortar that secure brickwork of the arched top. The prior art wood-burning oven comprises a built-up base made of rectangular bricks laid with their bad of brick on a support plate. The prior art wood-burning oven does not comprise a front wall and fuel charge and a subsequent placement of items for baking thereto is accomplished through an open window formed by the front end face of the arched top. Since the oven does not comprise a front wall, the streams of incandescent exhaust gases, which are produced as a result of fuel burning, circulate freely in the working space of the oven and exit unhindered not only through the chimney but also through the open window formed by the front end face of the arched top. This results in thermal balance disorder and temperature gradient non-uniformity in the working space of the oven. The internal (first) row of bricks of the arched top is heated non-uniformly this leading to the cracking of joints between the bricks, which form said rows of the arched top, and to oven disintegration.

The disadvantages of the prior art wood-burning oven include both complexity and labor intensity of the construction of the wood-burning oven due to, on the one hand, the necessity of form work to support the arched top when constructing the same and, on the other hand, the existence of the two rows of bricks used to form the arched top. The necessity of form work to support the internal (first) row of bricks is due to use of rectangular refractory bricks, which have standard geometrical dimensions and are bound to each other with the aid of earth mortar for masonry work. The external (second) row of bricks of the arched top made of lining bricks is laid over the internal (first) row of bricks of the arched top after the earth mortar has been dried up this making over construction process longer and more complex. In addition to the above-mention disadvantages, the disadvantages of the prior art wood-burning oven include a low heat storage capacity due to an inefficient heating of the oven because of the disturbance of the aerodynamic conditions of the movement of the streams of incandescent exhaust gases, which are produced as a result of fuel burning in the working space of the oven

Furthermore, known from the state of the art is a baking oven comprising a base or bottom; an arched top located above the base or bottom; a rear wall that connects the base or bottom to the arched top, and a front wall provided with an inlet opening, said walls and arched top forming a working space, which is intended for burning fuel and for a subsequent placement therein of cookware for preparing food, in particular, articles to be baked; an escape pipe installed at the upper portion of the arched top the arched top comprising at least two arched sections each of which comprises at least two segmental blocks and one keystone element to unite segmental blocks in the arched section (see U.S. Pat. No. 259,896 published on 20 Jun. 1882). The prior art baking oven comprises the base or bottom, which is formed of rectangular bricks constructed of refractory clay and laid upon the ground or other support without the interposition of cement or mortar. The upper faces of outer rows of bricks arranged on either side of the longitudinal axis of the base or bottom are provided with rectangular recesses, said recesses forming a continuous longitudinal recess at each of the base sides along the entire length of the oven. Said recess is used to accommodate a lower (supporting) portion of each segmental block while their upper portions bear a keystone element of the arched section. The front wall of the oven is formed of three segmental bricks, leaving a rectangular inlet opening for the insertion of fuel or articles to be baked. The rear wall of the oven is formed of two segmental bricks of such size as to entirely close the rear of the oven. The escape pipe for the products of combustion is arranged near the rear wall of the oven in the crown segmental block, which contacts to the rear wall of the oven and communicates the working space of the oven to the atmosphere. Where the segmental blocks, of which each arched section consists, adjoin each other, as well as where each segmental block mates with the keystone element and the segmental block mates with the respective brick included in the base or bottom, each segmental block has a flat contact surface adjoining the respective flat contact surface of the keystone element or brick mated therewith. The joints between the elements of the arched section (segmental blocks and the keystone element), between the segmental bricks, which close the rear of the oven, are filled with mortar, which prevents the oven assembled from being deformed and destroyed in the course of operation.

The disadvantages of the prior art wood-burning oven include both complexity and labor intensity of the construction thereof, as well as a low strength of the oven due to insufficient reliability of joints where the elements included in each arched section are fastened to each other due to the flatness of the contact surfaces of all of the arched section elements. The flatness of the contact surfaces of the arched section elements reduces the strength of connection of elements mating with each other in the junctions thereof.

Moreover, the disadvantages of the prior art wood-burning oven include the arrangement of the escape pipe in immediate proximity to the rear wall of the oven, this resulting in a low oven heating level due to a once-through circulation of the stream of incandescent exhaust gases, which are produced as a result of fuel burning in the working space of the oven, the movement direction whereof is set by the movement direction of air coming from the ambient atmosphere (from outside of the oven) through the inlet opening provided in the front wall into the working space of the oven, on the bottom whereof firewood is disposed, which is used as fuel. Air entering the fuel burning zone is heated and, being mixed with incandescent exhaust gases, which are produced as a result of fuel burning, moves along the oven bottom toward the inlet opening through the burning area into the escape pipe. The once-through principle of the movement of exhaust gases in the working space of the oven is, thus, implemented this resulting in inefficient aerodynamic conditions of oven operation. Heat produced by the oven, is carried quickly away from the oven this leading to a significant firewood consumption and a quick cooling of the oven after the session of their burning in the oven.

### SUMMARY OF THE INVENTION

In view of the above-mentioned disadvantages of the prior art, it is an objective of the present invention to provide a wood-burning oven that is simple to manufacture and install, as well as convenient and reliable in the course of operation.

It is another objective of the present invention to provide a wood-burning oven, which ensures an efficient heating of the oven and characterized by a high heat storage capacity owing to the optimization of aerodynamic conditions of the movement of exhaust gases produced by the combustion of wood fuel (firewood).

In order to achieve this objective, in the prior art wood-burning oven comprising a built-up base; an arched top located above the built-up base; a rear wall that connects the built-up base to the arched top, and a front wall provided with an inlet opening, said walls and arched top forming a working space, which is intended for burning fuel and for a subsequent placement therein of cookware for preparing food; a chimney installed at the upper portion of the arched top; the arched top comprising at least two arched sections each of which comprises at least two segmental blocks and one keystone element to unite segmental blocks in the arched section, in accordance with the present invention, the arched section further comprises two support blocks positioned opposite one another, each of which is mounted on the base and serves as a support for at least one segmental block, each segment block comprising a first shaped contact surface abutting a corresponding congruent shaped surface of the support block mated with said segmental block, and a second shaped contact surface abutting a corresponding congruent shaped surface of the keystone element mated with said segmental block, the chimney being installed in immediate proximity to the front wall of the oven and the size of the inlet opening in the front wall of the oven is less as compared with the cross-section of the working space.

The existence of the two support blocks positioned opposite one another, each of which is mounted on the base and serves as a support for at least one segmental block, makes it possible to increase the cross-section of the oven and the volume of the working space thereof.

Furthermore, the provision of each segmental block with the first shaped contact surface abutting a corresponding congruent shaped surface of the support block connected to said segment block makes it possible to increase the cross-section of the contact surface, through which the segmental block and support blocks mates with each other this ensuring a greater contact surface between the surfaces being mated with each other and a higher strength of joints between the oven elements.

Moreover, each segmental block comprises a second shaped contact surface abutting a corresponding congruent shaped surface of the keystone element connected to said segmental block, and the area of the contact surface, through which each segmental block mates with the keystone element, is increased as well this ensuring a greater contact surface between the surfaces being mated with each other and a higher strength of joints between the segmental blocks and the keystone element of each arched section of the oven.

The arrangement of the chimney in immediate proximity to the front wall of the oven makes it possible to ensure the optimum oven heating due to the circulation of the stream of incandescent exhaust gases, which are produced as a result of fuel burning in the working space of the oven. Baking bakery foods in the wood-burning oven is characterized in that they are baked in the working space of the oven once the oven is heated with the aid of firewood burnt in the working space of the oven and burnt down residues (coals) are removed from the working space of the oven. After the removal of the coals, the aerodynamic conditions of the movement of heated air masses are set within the working space, which conditions are determined by the atmospheric air entered through the inlet opening of the oven, which air moves along the oven bottom till contact to the rear wall of the oven, where the air stream alters its direction and rises toward a hot arched top of the oven, where it alters once more the direction of its movement, returns to the front wall of the oven and the inlet opening therein whose size is less as compared with the cross-section of the working space this being an additional obstacle for heated air escape through the inlet opening in the front wall, as a result thereof it (heated air) is discharged through the chimney outwards (to the atmosphere). A proper choice of a distance, B, at which the chimney is installed from the front wall of the oven makes it possible to ensure the optimum aerodynamic conditions in the working space of the oven for both firewood burning and the movement of heated air masses within the working space in the preparation of food, in particular, baking bakery foods.

The required aerodynamic conditions are, thus, ensured within the working space of the oven with a circulating motion of air entering from outside of the oven as a result of the above described movement of the heated air masses within the working space of the oven during the preparation of food, in particular, baking bakery foods, for example, pizza.

In view of the fact that air in the working space of the oven moves along as long as possible path, it is heated up to as high as possible temperature this ensuring both effective heating and slow cooling of the oven after the session of combustion of wood fuel (firewood).

In one embodiment of the wood-burning oven of the present invention, each support block serves as a support for at least two segmental blocks that mate therewith. This makes it possible to install multiple segmental blocks onto one support block this simplifying the installation of the oven and reducing labor intensity when constructing the same.

In another embodiment of the wood-burning oven of the present invention, the chimney is installed in immediate proximity to the front wall of the oven at a distance, B, from the front wall of the oven, which distance is determined as follows:

0.1L<B≤0.5L,

where:

B is the distance from the front wall of the oven, at which the chimney is installed, in mm; and
L is the total length of the oven, in mm.

The proper choice of the distance, B, from the front wall of the oven, at which the chimney is installed, makes it possible to ensure the optimum firewood burning conditions in the oven, as well as to ensure the optimum movement of heated air masses within the working space during the preparation of food, in particular, baked items.

The technical result of the claimed invention is the simplicity of both manufacture and installation of the wood-burning oven, as well as reliability when in operation and the convenience of maintenance.

### BRIEF DESCRIPTION OF THE DRAWINGS

FIG. 1 is a perspective view of the wood-burning oven in accordance with the present invention;

FIG. 2 is a perspective view of the wood-burning oven in accordance with the present invention (the same as in FIG. 1);

FIG. 3 is a front view of the wood-burning oven shown in FIG. 2;

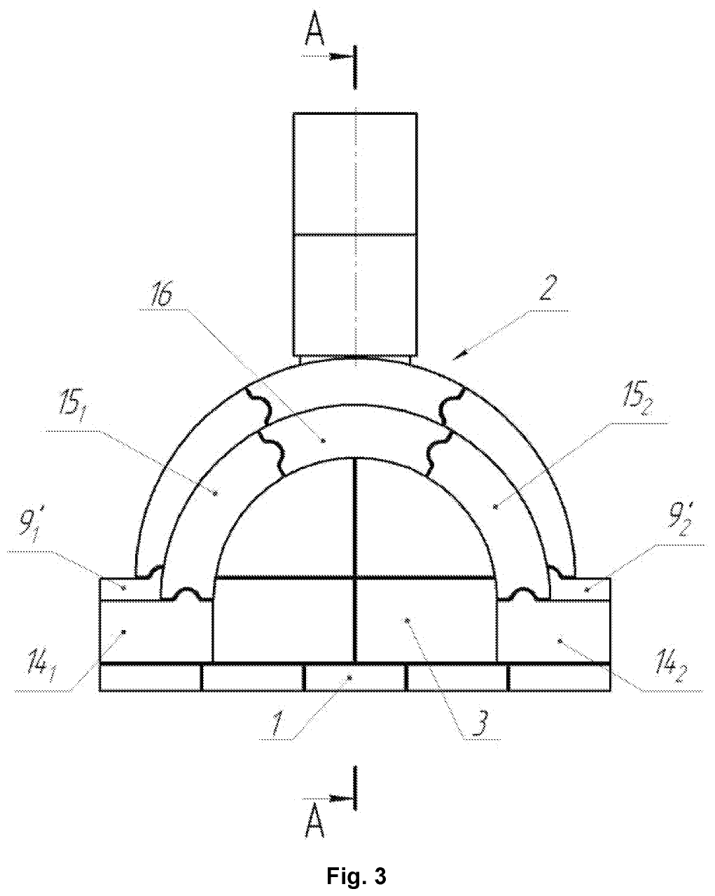

FIG. 4 is a side view of the wood-burning oven shown in FIG. 2;

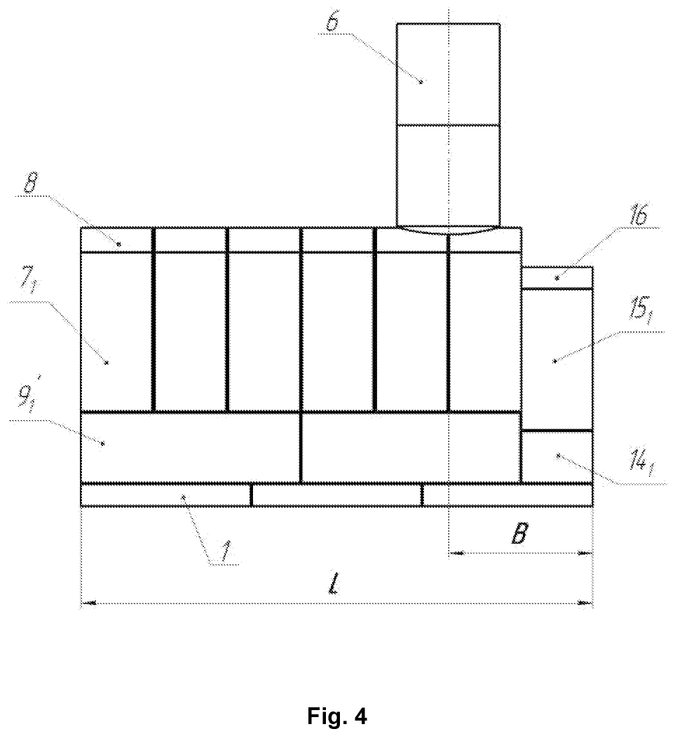

FIG. 5 is a cross-sectional view taken along line A-A of FIG. 3;

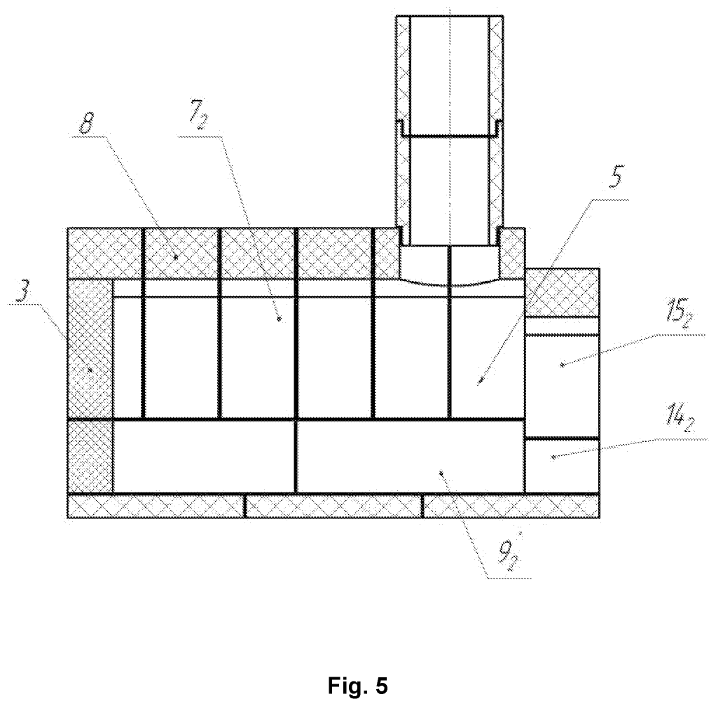

FIG. 6 shows the assembly of the wood-burning oven shown in FIG. 2;

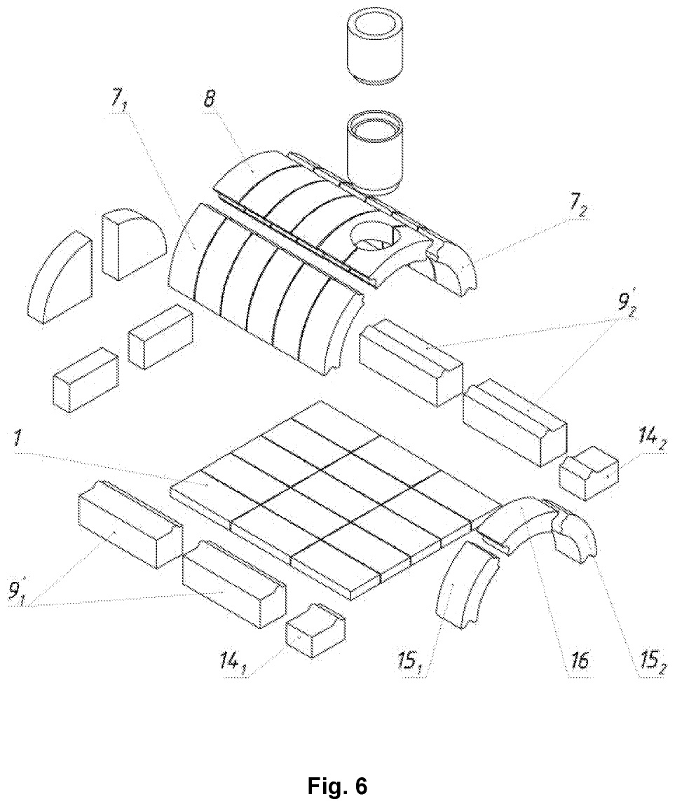

FIG. 7 is an exploded view of the arched top of the oven shown in FIG. 1; and

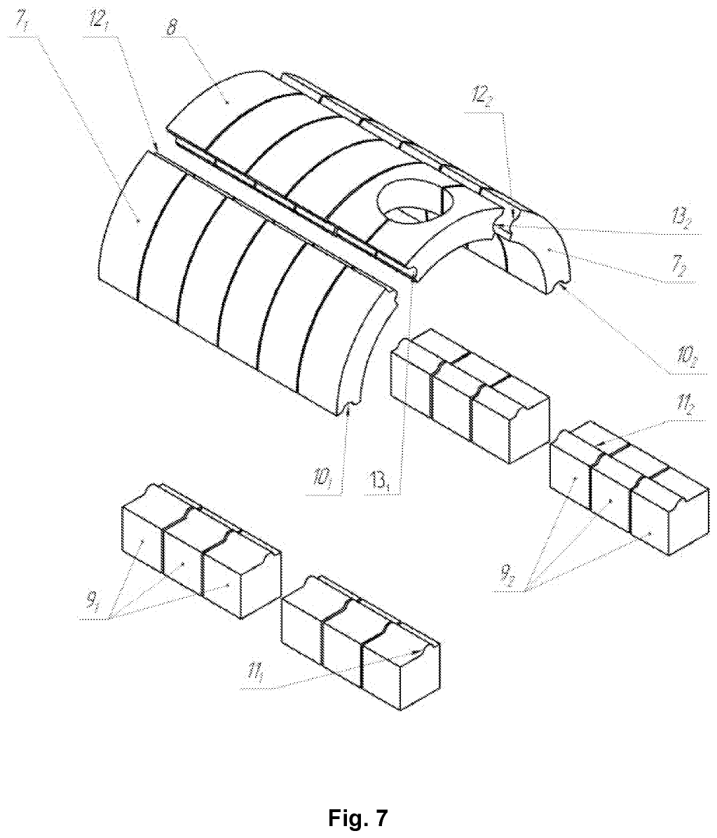

FIG. 8 is an exploded view of the front wall in the form of an additional arched section.

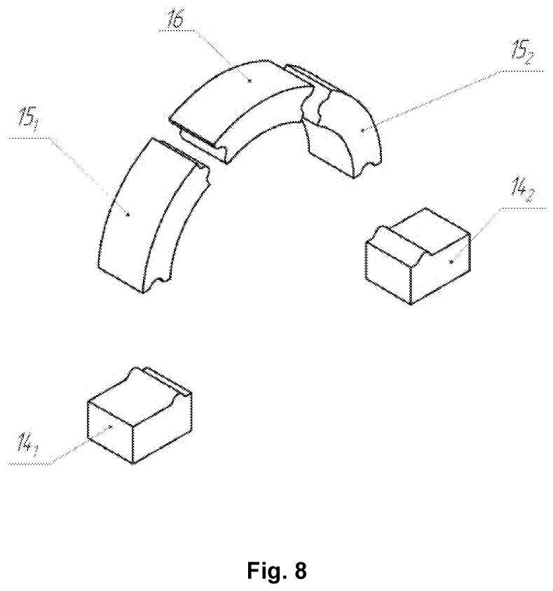

### DETAILED DESCRIPTION OF THE INVENTION

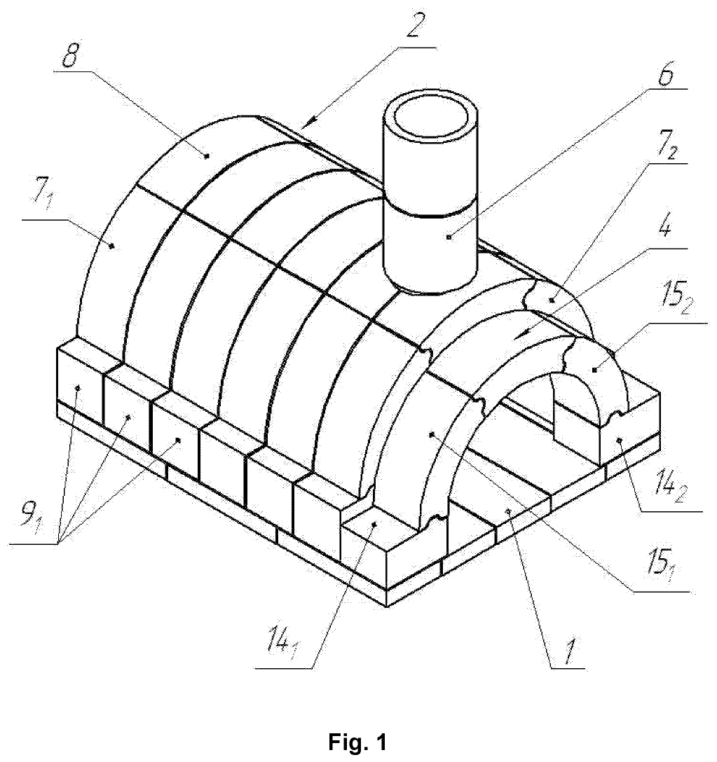

Referring first to FIG. 1, the wood-burning oven in accordance with the present invention comprises a built-up base 1; an arched top 2 located above the built-up base 1; a rear wall 3 that connects the built-up base 1 to the arched top 2, and a front wall provided with an inlet opening. Said elements form a working space 5 of the oven ne [symbol] , which is intended for burning fuel and for a subsequent placement therein of cookware for preparing food. The wood-burning oven comprises also a chimney 6 installed at the upper portion of the arched top 2, the arched top 2 comprising at least two arched sections each of which comprises at least two segmental blocks 7₁ and 7₂ and one keystone element 8 unite segmental blocks 7₁ and 7₂ in the arched section. Each arched section 5 further comprises two support blocks 9₁ and 9₂ positioned opposite one another, each of which is mounted on the base 1 and serves as a support for at least one of the segmental blocks 7₁ and 7₂, respectively. The segmental block 7₁ comprises a first shaped contact surface 10₁ abutting a corresponding congruent shaped surface 11₁ of the support block 9₁ that mates with said segmental block, and a second shaped contact surface 12₁ abutting a corresponding congruent shaped surface 13₁ of the keystone element 8 that mates with said segmental block. The segmental block 7₂ comprises a first shaped contact surface 10₂ abutting a corresponding congruent shaped surface 11₂ of the support block 9₂ that mates with said segmental block, and a second shaped contact surface 12₂ abutting a corresponding congruent shaped surface 13₂ of the keystone element 8 that mates with said segmental block.

The front wall 4 is configured in the form of an additional arched section, which comprises two additional support blocks 14₁ and 14₂, two additional segmental blocks 15₁ and 15₂, as well as an additional keystone element 16 intended to connect the additional segmental blocks 15₁ and 15₂ to each other. The additional support blocks 14₁ and 14₂, the additional segmental blocks 15₁ and 15₂, as well as the additional keystone element 16 have smaller geometrical dimensions as compared with the respective support blocks 9₁ and 9₂, the segmental blocks 7₁ and 7₂, and the keystone element 8 this making it possible to reduce the size of the inlet opening in the front wall 4 of the oven as compared with the cross-section of the working space 5 thereof.

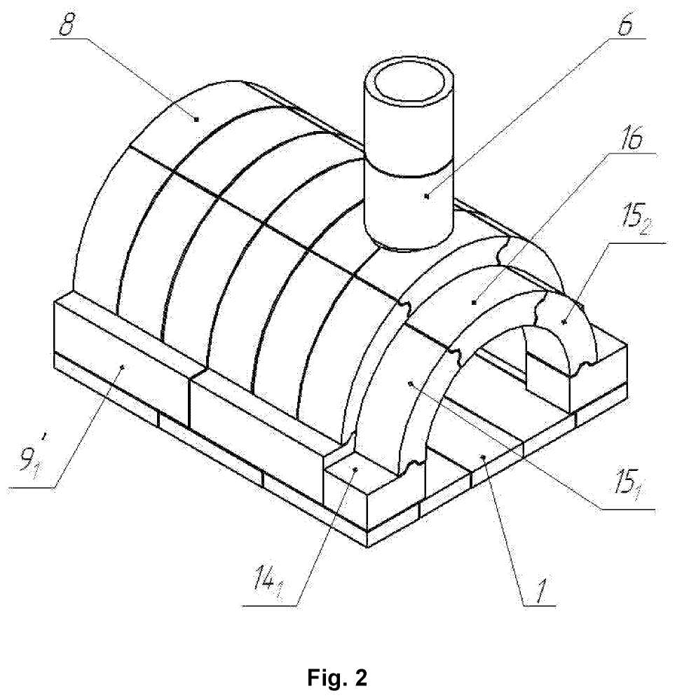

According to a preferred embodiment of the wood-burning oven of the present invention, a support block 9₁¹ (shown in FIG. 2) serves as a support for at least two segmental blocks 7₁, which mate with said support block and a support block 9₂¹ serves as a support for at least two segmental blocks 7₂, which mate with said support block.

The keystone element 8 comprises at least two shaped contact surfaces 13₁ and 13₂. The contact surface 13₁ abuts the corresponding congruent shaped surface 12₁ of the first segmental block 7₁ mated therewith, which is included in the arched section. The second contact surface 13₂ of the keystone element 8 abuts the corresponding congruent shaped surface 12₂ of the second segmental block 7₂ mated therewith, which is included in the same arched section.

The chimney 6 is installed in immediate proximity to the front wall 4 of the oven at a distance, B, from the front wall of the oven, which distance is determined as follows:

0.1L<B≤0.5L,

where:

B is the distance from the front wall 4 of the oven, at which the chimney 6 is installed, in mm; and;

L is the total length of the oven, in mm.

Advantageously, the chimney 6 is installed at the distance, B, from the front wall 4 of the oven chosen within the range from 0.12L to 0.35L.

The distance, B, chosen from the front wall 4 of the oven, at which the chimney 6 is installed, ensures the optimum movement of heated air masses within the working space 5 during the preparation of food this making it possible to ensure a uniform heating of food being cooked, in particular, items to be baked.

A yet another embodiment of the present invention provides a method for the installation of the wood-burning oven of the present invention.

A place for the installation of the wood-burning oven is first prepared. The oven is placed on a foundation whose height is chosen based on the convenience of wood-burning oven operation. The built-up base 1 is formed of rectangular refractory bricks with firebricks being used as such bricks. The firebricks are laid with their bed on the foundation of the oven. The arched sections of the arched top 2 are then formed. To form each arched section, the support blocks 9₁ and 9₂ positioned opposite one another are installed on the foundation 1. In doing so, horizontal joints between the support blocks 9₁, 9₂ and the base 1 are made of lime mortar or another suitable earth mortar. Then, on the shaped surface 11₁ of the support blocks 9₁, the first shaped surface 10₁ of the segmental block 7₁ congruent thereto is placed, and, on the shaped surface 11₂ of the support blocks 9₂, the first shaped surface 10₂ of the segmental block 72 congruent thereto is placed. Between the second shaped surface 12₁ of the segmental block 7₁ and the second shaped surface 12₂ of the segmental block 7₂, the keystone element 8 with the shaped surfaces 13₁ and 13₂, which contacts to the congruent surfaces 12₁ and 12₂ of the respective segmental blocks 7₁ and 7₂, is installed. In a similar way, the additional arched section is assembled, which section serves as the front wall 4 of the oven. The rear wall 3 of the oven is laid from the base 1 to the arched top 2. All the joints between the oven elements are filled with lime mortar or earth mortar. The chimney 6 is installed at the upper portion of the arched top at the distance, B, from the front wall 4 of the oven. Once the oven is built, the joints between the oven elements are covered with lime mortar or earth mortar both within and outside the working space 5 of the oven.

The base 1, the arched top 2, the rear wall 3, and the front wall 4 provided with the inlet opening, form the working space 5 of the oven intended for burning fuel and for a subsequent placement therein of cookware for preparing food. In the working space 5, fuel burns with heat transfer to all the oven elements. The working space 5 accommodates the required quantity of fuel and ensures a sufficient air intake to the burning fuel and a high temperature in the burning area for the efficient heating of all the oven elements. Flue gases, which are produced in the working space as a result of fuel combustion, rise and fill the chimney 6. The distance, B, at which the chimney 6 is installed from the front wall 4 of the oven is chosen so as to ensure the optimum firewood burning conditions in the oven, as well as to ensure the optimum movement of heated air masses within the working space during the preparation of food, in particular, baking pizza.

Once the oven is built and covered with mortar, a trial operation of the oven is carried out. For this, a small quantity of wood fuel is laid into the working space 5 of the oven and is set a fire. Following 30 to 40 minutes, when the temperature rises up to 400 to 500° C., the burning fuel is moved toward the rear wall 3 of the oven, as a result whereof the optimum aerodynamic conditions of the movement of heated air masses within the working space are achieved. The oven should not be strongly heated for it may crack in the joints filled with lime mortar or another binder. Burning with small quantities of fuel is continued for 3-5 days once daily in summer and twice daily in winter and autumn. Only if these requirements are complied with, the oven is dried up gradually and develops no crack subsequently.

Articles to be baked, for example, pizza, are laid directly onto the base 1 of the oven and are cooked being rotated for the most uniform baking. After 2 to 4 minutes, depending on the type of pizza, it is removed out of the oven.

Technical Result

The technical result of the claimed invention is the simplicity of the manufacture of the wood-burning oven and the reliability of its operation, as well as a high heat storage capacity owing to the optimization of aerodynamic conditions of the stream of exhaust gases produced by the combustion of wood fuel.

1. A wood-burning oven comprising a built-up base; an arched top located above the built-up base; a rear wall that connects the built-up base to the arched top, and a front wall provided with an inlet opening, said walls and arched top forming a working space, which is intended for burning fuel and for a subsequent placement therein of cookware for preparing food; a chimney installed at the upper portion of the arched top; the arched top comprising at least two arched sections each of which comprises at least two segmental blocks and one keystone element to unite segmental blocks in the arched section, characterized in that the arched section further comprises two support blocks positioned opposite one another, each of which is mounted on the base and serves as a support for at least one segmental block, each segment block comprising a first shaped contact surface abutting a corresponding congruent shaped surface of the support block mated with said segmental block, and a second shaped contact surface abutting a corresponding congruent shaped surface of the keystone element mated with said segmental block, the chimney being installed in immediate proximity to the front wall of the oven and the size of the inlet opening in the front wall of the oven is less as compared with the cross-section of the working space thereof.

2. The wood-burning oven as claimed in claim 1, characterized in that each support block serves as a support for at least two segmental blocks that mate therewith.

3. The wood-burning oven as claimed in claim 1, characterized in that the chimney is installed at a distance, B, from the front wall of the oven, which distance is determined as follows:
0.1L<B≤0.5L,
where:
B is the distance from the front wall 4 of the oven, at which the chimney 6 is installed, in mm; and
L is the total length of the oven, in mm.
